(19) United States
(12) Patent Application Publication
(10) Pub. No.: US 2014/0236586 A1
(43) Pub. Date: Aug. 21, 2014

(54) METHOD AND APPARATUS FOR COMMUNICATING MESSAGES AMONGST A NODE, DEVICE AND A USER OF A DEVICE

(71) Applicant: TELEFONAKTIEBOLAGET L M ERICSSON (PUBL), (US)

(72) Inventor: Kshitiz Singh, San Jose, CA (US)

(73) Assignee: TELEFONAKTIEBOLAGET L M ERICSSON (PUBL), Stockholm (SE)

(21) Appl. No.: 13/769,748

(22) Filed: Feb. 18, 2013

(51) Int. Cl. G10L 21/02

(52) U.S. Cl. CPC G10L 21/0202
USPC 704/211; 704/270; 704/267; 704/201

(57) ABSTRACT

An method and apparatus that modifies static media, such as music files being played to a user of the device, upon the generation or receipt of an alert, notification or message, so that information in the alert, notification or message can be incorporated into the media files then communicated to the user. In a further embodiment, a user's response to the communicated information can be sensed using one or more sensors and transducers so as to provide feedback to the device, and then optionally to a node in a system.

### FIELD

Embodiments of the invention relate to the field of machine-to-machine and machine-to-user communication.

### BACKGROUND

Natural language processing algorithms implemented by computer processors coupled to memory and databases are becoming more reliable and accurate as computer processing speeds and look-up operations increase and as gate sizes decrease. These algorithms are key to voice-based human-computer interactions, such as those used in automobile navigation systems.

There are applications available today to provide an unmodified voice based alert or message to a person that is at the same time listening to music. In one aspect, the unmodified voice based alert or message is played over the music. Such an application is an exercise or training application. Using this application, one can be jogging while listening to music and using the training system in the background. The application provides feedback about the training session to the user using an un-modified voice over, and in conflict with, the music. As can be expected, this may make it difficult to understand the message as there are two vocal signals being delivered to the user simultaneously. In an alternative embodiment, the training application system causes the media, such as music, to stop, lag or the volume reduced, then provides the feedback, and then continues the media from where it was stopped, slowed or the volume reduced. This approach disadvantageously creates a jarring or abrupt transition between the music and the message, disrupting timing and pace for the user. Furthermore, in order to provide voice-based user input to the system, one may have to lower the music volume level. If the application requires user input using tactile interaction, then the user must shift attention from what the user is doing to react to the message or alert.

### SUMMARY

Embodiments of the invention include methods performed (i) by a device, (ii) by a node, (iii) by a node in communication with a device and (iv) by a device in communication with a node. Further embodiments of the invention include (v) a node performing actions and communicating with a device so as to provide an informational alert, notification or message to a user of the device (vi) a device performing actions in response to a notification from a node in furtherance of alerting the user of the device of a message, and (vii) a device performing actions in response to a notification locally in furtherance of alerting or notifying the user of the device of a message. Additional embodiments of the invention include (vii) a database accessible by a node to obtain aspects of media matched to media being communicated by a device to a user.

The invention provides a novel method of facilitating interaction between a user and a device using a media source, such as a music file, the method requiring lesser cognitive effort than that of tactile and/or voice based interaction via the device. The invention further facilitates interaction between a node and a device while a user of the device is using a media source, such as a music file. The invention modifies static media, such as music files being played to a user of the device, upon the generation or receipt of an alert, notification or message, so that information in the alert, notification or message can be incorporated into the media files then communicated to the user. In a further embodiment, a user's response to the communicated information can be sensed using one or more sensors and transducers so as to provide feedback to the device, and then optionally to a node in a system. These user responses could be tapping of feet or hands with the user performing these actions with the intention to interacting with the device or node.

### BRIEF DESCRIPTION OF THE DRAWINGS

The invention may best be understood by referring to the following description and accompanying drawings that are used to illustrate embodiments of the invention. In the drawings:

FIG. 1 is a flow chart of a first embodiment of the present invention;

FIG. 2 is a flow chart of a second embodiment of the invention focusing on operations occurring at a node;

FIG. 3 is a flow chart of a third embodiment of the invention focusing on operations occurring at a device;

FIG. 4 is a state diagram of a fourth embodiment of the invention;

FIG. 5 is a state diagram of a fifth embodiment of the invention;

FIG. 6 is a block diagram of a node operable to interact with a device according to embodiments of the invention; and

FIG. 7 is a block diagram of a device operable to interact with a node according to embodiments of the invention; and

FIG. 8 is a block diagram of a system according to embodiments of the invention.

### DESCRIPTION OF EMBODIMENTS

The following description describes methods and apparatus for alerting a user of a device, such device being, for example, a terminal, smart-phone, network coupled music or media player or user equipment, of an alert, notification or message, such as a response message based on physical parameters, a response message from a background process on the device or response messages from a node such as an incoming telephone call notification, text message or the like, the alert, notification or message being combined with a media file that is then being played by the device, such combination being performed in a seamless manner.

In the following description, numerous specific details such as logic implementations, op-codes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

To ease understanding, dashed lines have been used in the figures to signify the optional nature of certain items (e.g., features not supported by a given implementation of the invention; features supported by a given implementation, but used in some situations and not in others).

The techniques shown in the figures can be implemented using code and data stored and executed on one or more electronic nodes and/or devices. Such electronic nodes and/or devices store and communicate (internally and/or with other electronic nodes and/or devices over a network) code and data using non-transitory tangible machine readable medium (e.g., magnetic disks; optical disks; read only memory; flash memory devices; phase-change memory) and transitory machine-readable communication medium (e.g., electrical, optical, acoustical or other forms of propagated signals-such as carrier waves, infrared signals, digital signals, etc.). In addition, such electronic nodes and/or devices typically include a set or one or more processors coupled with one or more other components, such as a storage device, one or more input/output devices (e.g., keyboard, a touch-screen, and/or a display), and a network connection. The coupling of the set of processors and other components is typically through one or more busses or bridges (also termed bus controllers). The storage node and/or device and signals carrying the network traffic respectively represent one or more non-transitory tangible machine readable medium and transitory machine-readable communication medium. Thus, the storage device of a given electronic device typically stores code and/or data for execution on the set of one or more processors of that electronic device. Of course, one or more parts of an embodiment of the invention may be implemented using different combination of software, firmware, and/or hardware.

In embodiments of the invention, If a node or plurality of nodes in a system is attempting to communicate an alert, notification or message to a device while the device has a media file in operation, for example, music is being played to the user of the device, the invention modifies the alert, notification or message, and optionally, the media file, and then presents the alert, notification or message seamlessly to the user. In an example, the invention may determine the voice of the artist embodied in the media file, modify the alert, notification or message so it is presented in the voice of that artist, then insert the modified alert, notification or message into the existing media file so that the same rhythm continues to play.

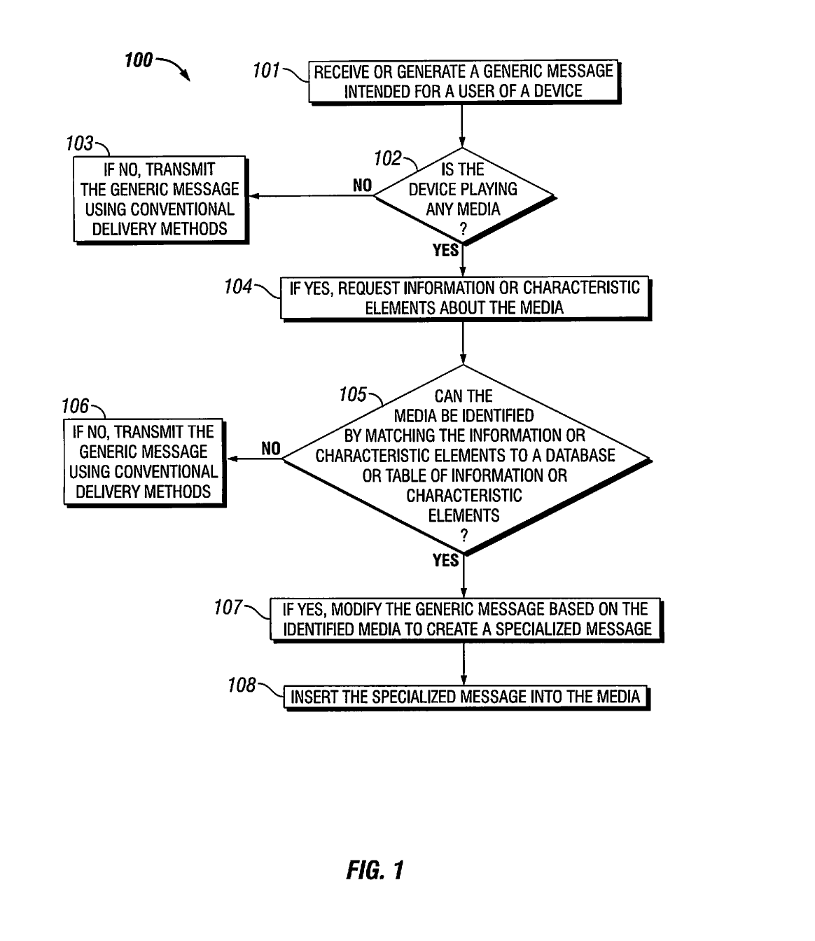

FIG. 1 is a flow chart 100 of a first embodiment of the present invention. The invention communicates an alert, notification or message (collectively referred to hereinafter and in the appended claims as a “message”) to a user of a device by receiving or generating by a device a generic message intended for a user of a device 101, then determining whether the device is playing any media 102 using conventional delivery methods. If the device is not playing media, playing or transmitting the generic message 103. If it is determined the device is playing media, requesting information or characteristic elements about the media 104. Then determining whether the media can be identified by matching the information or characteristic elements to a database or table of information or characteristic elements 105. If the media is not identifiable, transmitting or playing the generic message 106 using conventional delivery methods. If the media is identifiable, modifying the generic message based on the identified media to create a specialized message 107. The final step is to insert the specialized message into the media 108.

In further embodiments, the invention comprises playing the specialized message by the device. Further, the message may be generated by a background process on a device. In a further embodiment, the message is generated at a node coupled over a channel to the device. In a further embodiment, the device is playing the media locally and the node obtains information about the media using a protocol for delivering and receiving messages between the node and the device. The media can be a selection being operated by a media player component of the device or the device can be streaming the media over a network and a node obtains information about the media from one selected from the network, and more specifically, a database residing on a server on the network, and the device. Using structure information about the media, the generic message is modified so that the specialized message is seamlessly inserted into the media. The generic message can be modified based on information or characteristic elements of the media. The information about the media can be a meta element, meta data, metatag or tag. The characteristic elements of the media can be selected from the group consisting of tempo, rhythm, pitch, timing or frequency. In an embodiment, the media is a musical selection, and the generic message is transformed into a specialized message that is inserted into the music selection in a manner in which the timing, rhythm, tempo, pitch and pacing of the musical selection is maintained. In a further embodiment, the media is a vocal selection, and the generic message is transformed into a specialized message that is inserted into the vocal selection in a manner in which the timing, rhythm, tempo, pitch or pacing of the vocal selection is maintained.

For example, if a user of the device is engaging in exercise with an exercise file operating in the background (for example, keeping track of physical parameters of the user sensed by sensors coupled to the device), and a specific song by a specific artist is being played by the device media player, the invention operates to provide training feedback using the same artist's voice and in time with the song's rhythm. This can be implemented using a database containing artists' voices coupled to a processor running a real-time audio-processing algorithm. In that way, artist's voice can be identified by operations on the processor making reference to the database.

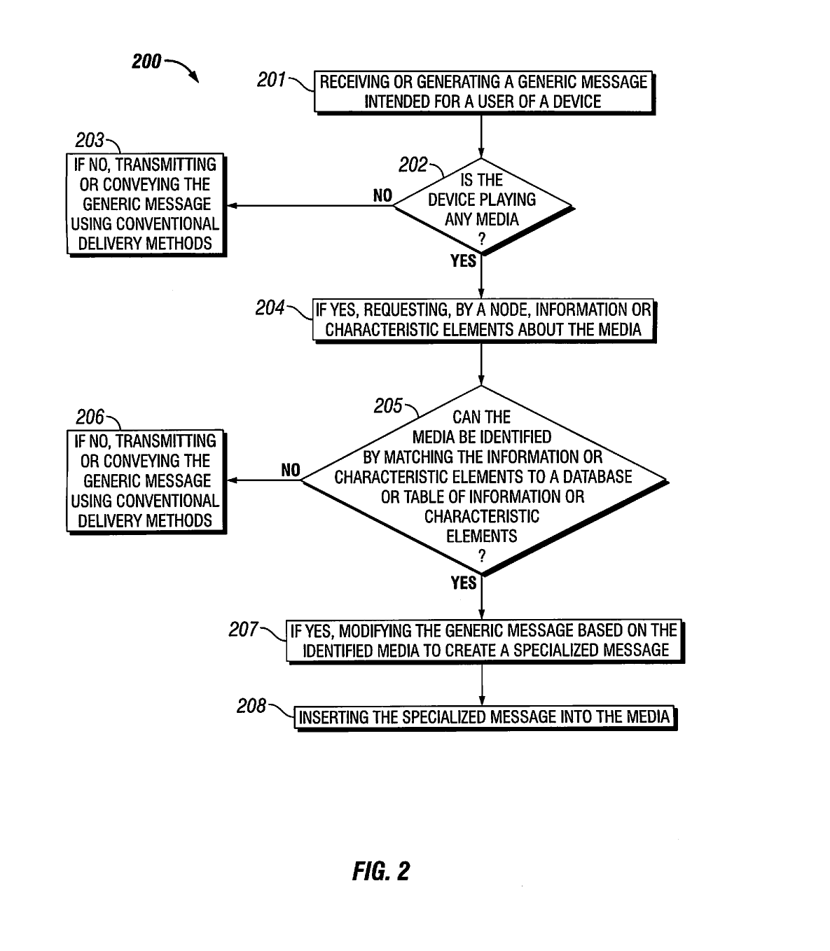

FIG. 2 is a flow chart 200 of a second embodiment of the invention focusing on operations occurring at a node. This method comprises communicating a message to a user of a device, by receiving or generating a generic message intended for a user of a device 201 and then determining whether the device is playing any media 202. If the device is not playing media, the generic message is conveyed or transmitted 203 using conventional delivery methods. If it is determined the device is playing media, a node requests information or characteristic elements about the media 204. It is then determined whether the media can be identified by matching the information or characteristic elements to a database or table of information or characteristic elements 205. If the media is not identifiable, the generic message is conveyed or transmitted by a device 206 using conventional methods. If the media is identifiable, then the generic message is modified based on the identified media to create a specialized message 207 and the specialized message is inserted into the media 208.

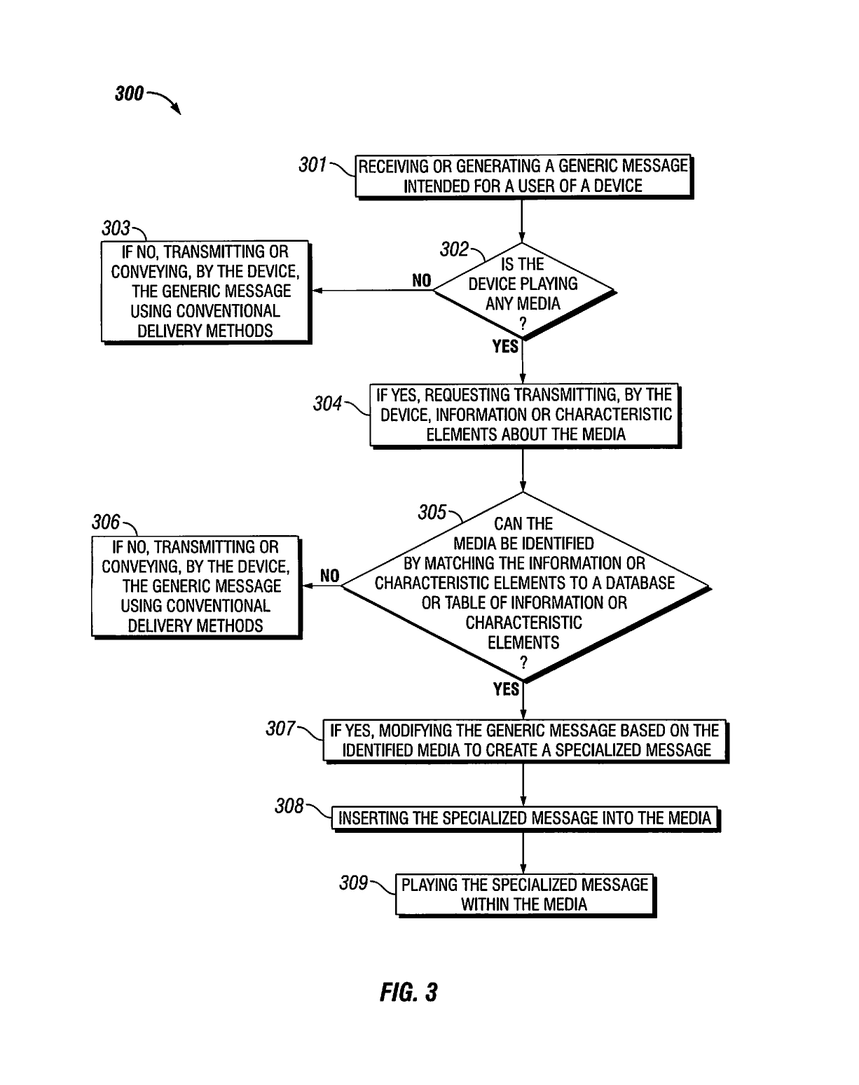

FIG. 3 is a flow chart 300 of a third embodiment of the invention focusing on operations occurring at a device. This method comprises receiving or generating a message and then conveying the message to a user of a device. A generic message intended for a user of a device is received or generated by the device 301. It is then determined whether the device is playing any media 302. If the device is not playing other media, the generic message is conveyed or transmitted 303 using conventional methods. If it is determined the device is playing media, information or characteristic elements about the media 304 is requested. It is then determined whether the media can be identified by matching the information or characteristic elements to a database or table of information or characteristic elements 305. If the media is not identifiable, the generic message is transmitted or conveyed by the device to the user 306 using conventional methods. If the media is identifiable, then the generic message is modified based on the identified media to create a specialized message 307. The specialized message is inserted into the media 308 and delivered by the device to the user 309.

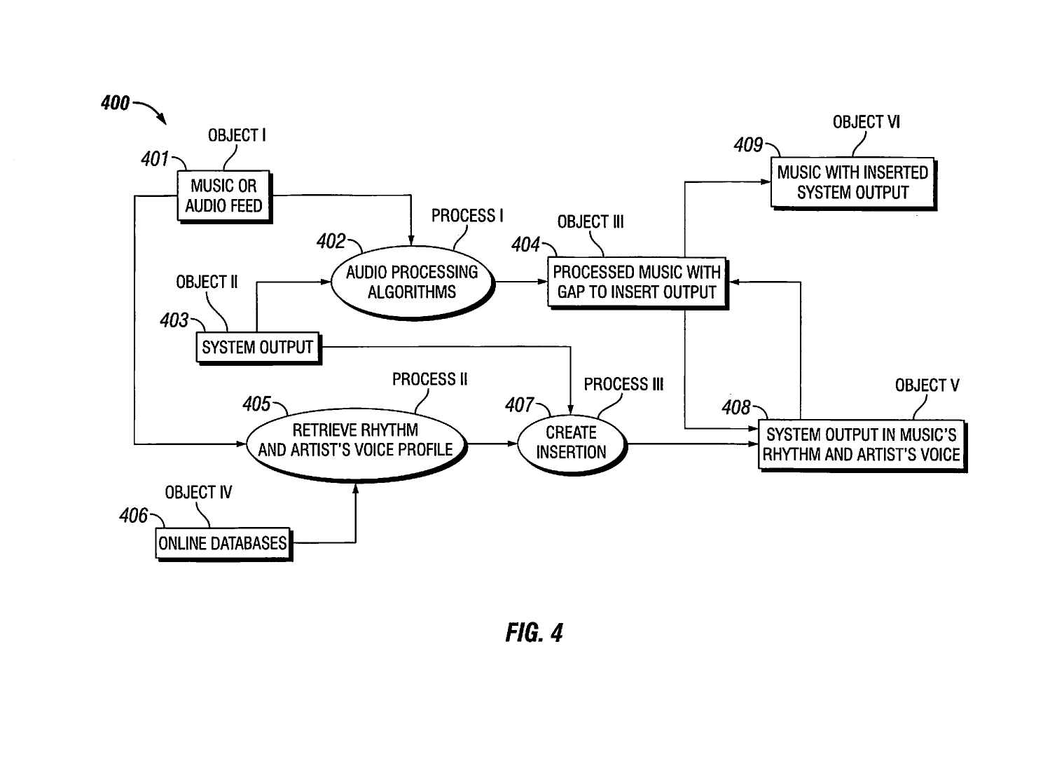

FIG. 4 is a state diagram 400 of a fourth embodiment of the invention. As seen therein, there are three core processes. The current media file or the running playlist 401 (OBJECT I) is analyzed 402 (PROCESS I) with output 403 (OBJECT II) to be conveyed by the device to the user. The result is a processed media file with a gap 404 (OBJECT III) in which to insert the output 403 in a manner that does not interrupt the flow of the media, such as music, or in which the interruption is negligible. After gap 404 is created, the invention re-analyzes the media 405 (PROCESS II) and compares it with online media databases 406 (OBJECT IV). The purpose is to, inter alia, retrieve rhythm information and artist's voice profile so that output 403 is modified 407 (PROCESS III) using the artist's voice with media's then current rhythm, e.g., in the background. After the process is completed, the compiled insertion 408 (OBJECT V) is combined with the media in the gap 404 (OBJECT III) to generate a final output 409 (OBJECT VI), i.e., a media file with the inserted output which is in artist's voice and in rhythm, tempo or time with the media, ecuh as music. To foregoing processes occur in real-time or in near-real time.

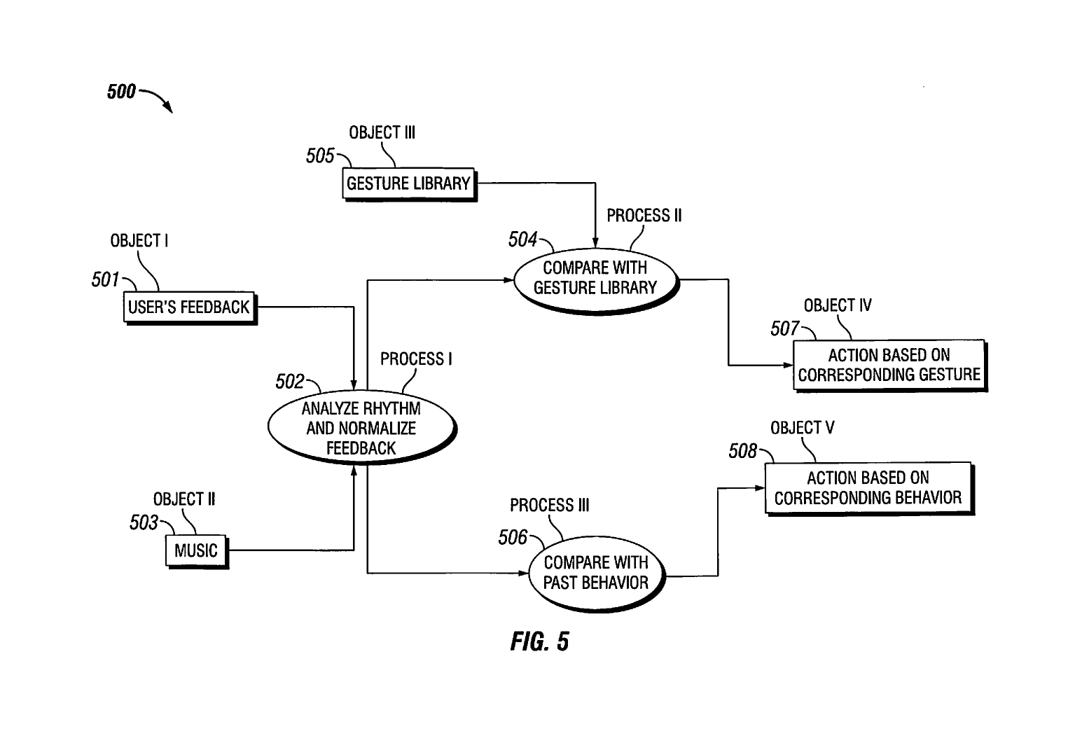

FIG. 5 is a state diagram 500 of a fifth embodiment of the invention. This embodiment defines method and apparatus that enables a user to provide input and/or feedback to a device, node or system that implements the method of the invention. For example, a sensor coupled to the invention can sense slightly deviated behavior that a user otherwise would perform naturally in response to music. Examples include responding to the media or music by the user tapping their feet faster, waving an arm, hand, foot or leg at angles in excess of an average measured angle, clapping hands, snapping the fingers, and the like. The foregoing are only illustrative examples and are not intended to be limiting.

As seen in FIG. 5, user feedback 501 (OBJECT I) is collected through appropriate sensors that are able to recognize gestures, body movements and sounds. The invention then analyzes the stimuli 502 (PROCESS I) against the media, such as music 503 (OBJECT II) to determine if the feedback was a natural response or deviated natural response done intentionally to trigger an action. The invention normalizes the feedback 502 (PROCESS I) against the rhythm of music. Hence, the rate at which the gestures are performed vary depending on the rate or tempo of the music. A user would have to, e.g., tap their feet faster if the music had a fast tempo to communicate that they want to perform or trigger an action, in contrast to a musical selection that had a slow tempo. After the feedback is normalized, it is compared 504 (PROCESS II) to data in an existing gesture library 505 (OBJECT III). The gesture library can either be entirely generated by a user or can be based on default actions modified and customized according to user preferences. If the gesture library is absent or if the results of the analysis need be validated, the results can be compared with a user's history/past behavior 506 (PROCESS III). Based on 504 (PROCESS II) and 506 (PROCESS III), appropriate actions can be derived either from gestures 507 (OBJECT IV) or from past history 508 (OBJECT V) or both which can be validated by comparing one against the another. This action can then be translated into system interaction.

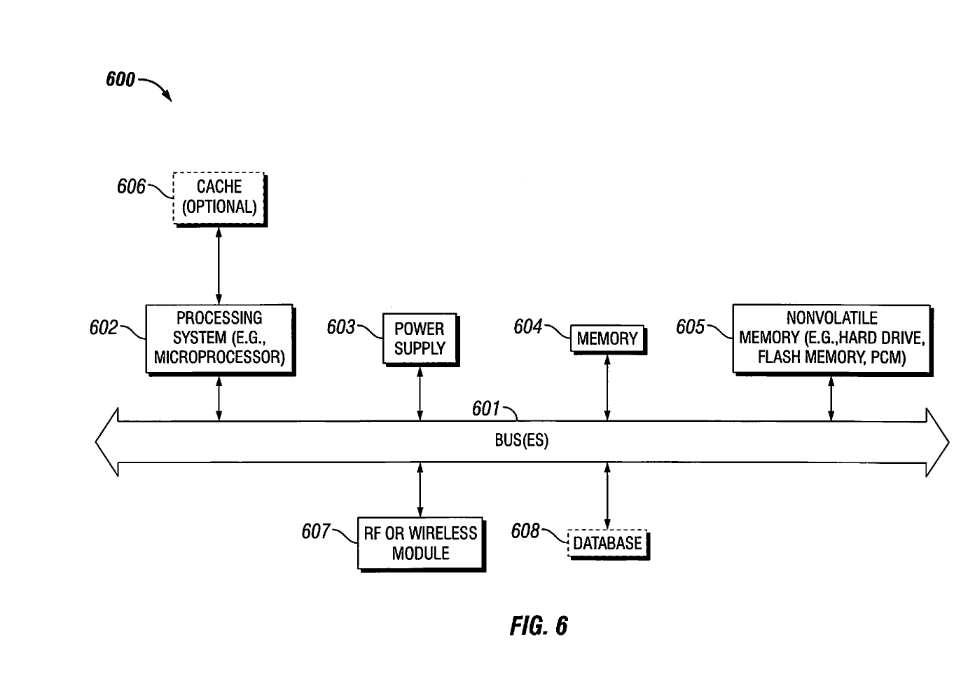

FIG. 6 is a block diagram of a node 600 operable to interact with a device according to embodiments of the invention. Those skilled in the art would recognize that other computer systems used to implement the node may have more or less components and may be used in the disclosed embodiments. The node 600 includes a bus(es) 601 coupled with a microprocessor 602, a power supply 603 and volatile memory 604 (e.g., double data rate random access memory (DDR-RAM), single data rate (SDR) RAM), nonvolatile memory 605 (e.g., hard drive, flash memory, Phase-Change Memory (PCM), both of the foregoing types of memory being non-transitory, computer readable memory. The processor 602 may be further coupled to a cache 606. The processor 602 retrieve instruction(s) from the volatile memory 604 and/or the nonvolatile memory 605, and executes the instruction to perform operations and method described above. The bus(es) 601 couples the above components together. Node 600 is operable to communicate a message via a radio frequency (RF) or wireless module 607 to a user of a device, by receiving or generating a generic message intended for a user of a device and then determining whether the device is playing any media. If the device is not playing media, the generic message is transmitted by node 600. If it is determined the device is playing media, node 600 requests information or characteristic elements about the media. It is then determined whether the media can be identified by matching the information or characteristic elements to a database or table of information or characteristic elements 608 contained within node 600 or by reference to a separate database on the network to which the node 600 is coupled. If the media is not identifiable, the generic message is played by a device. If the media is identifiable, then the generic message is modified based on the identified media to create a specialized message and the specialized message is inserted into the media.

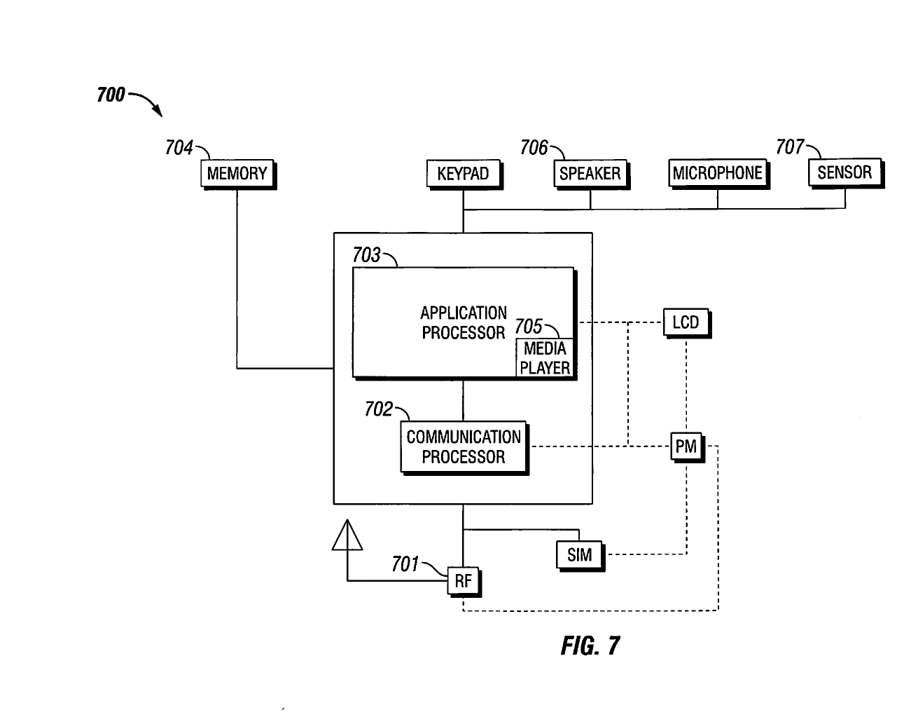

FIG. 7 is a block diagram of a device 700 operable to interact with a node according to embodiments of the invention. As seen therein, a generic message is either received at wireless or RF module 701 an processed at communication processor 702 or generated by application processor 703 running instructions stored at memory 704, the message being intended for conveyance via a transducer, such as speaker 706, to the user of device 700. It is then determined by application processor 703 alone, or via communication by communication processor 702 and wireless or RF module 701 with the network, whether the media player 705 of device 700 is playing any media. If the device 700 is not playing other media, the generic message is conveyed to the user. If it is determined the device is playing media, information or characteristic elements about the media is requested. It is then determined whether the media can be identified by matching the information or characteristic elements to a database or table of information or characteristic elements contained in memory 704 or in the network. If the media is not identifiable, the generic message is transmitted or conveyed by the device 700 to the user. If the media is identifiable, then the generic message is modified based on the identified media to create a specialized message. The specialized message is inserted into the media and delivered by the device 700 to the user. Sensor 707 is included within the device 700 to perform the trigger actions described in FIG. 5.

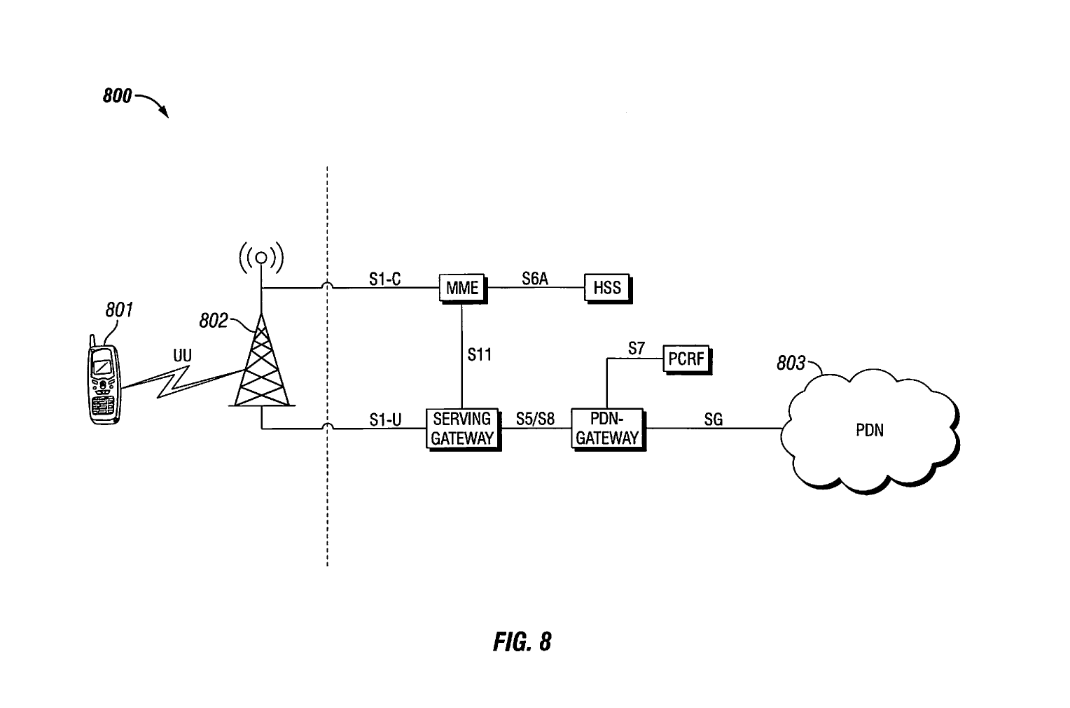

FIG. 8 is a block diagram of a system 800 according to embodiments of the invention. As seen therein, device 801 includes a media player. A generic message is either locally generated at device 801 or can be generated at a node external to the device, for example, at th eNodeB 802 or at a node within the packet data network 803. It is then determined whether the device 801 is playing any media. If the device 801 is not playing other media, the generic message is transmitted or conveyed to the user of the device 801. If it is determined the device 801 is playing media, information or characteristic elements about the media is requested either by device 801 or by a node external thereto, for example, in the packet data network 803. Packet data network 803 comprises the links and nodes connected thereby, including database and content servers. It is then determined whether the media can be identified by matching the information or characteristic elements to a database or table of information or characteristic elements. If the media is not identifiable, the generic message is transmitted or conveyed by the device 801 to the user. If the media is identifiable, then the generic message is modified based on the identified media to create a specialized message. This operation can be done locally within device 801, or in communication with packet data network 803. The specialized message is inserted into the media and delivered by the device 801 to the user.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element). Such electronic devices store and communicate (internally and/or with other electronic devices over a network) code and data using computer -readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for sending a message to a device, comprising the steps of:
receiving or generating a generic message intended for play by the device;
determining whether the device is playing any media;
if it is determined the device is not playing media, playing the generic message by the device;
if it is determined the device is playing media, requesting information or characteristic elements about the media;
determining whether the media can be identified by matching the information or characteristic elements to a database or table of information or characteristic elements;
if the media is not identifiable, playing the generic message by the device;
if the media is identifiable, modifying the generic message based on the identified media to create a specialized message; and
inserting the specialized message into the media.

2. The method of claim 1, further comprising playing the specialized message by the device.

3. The method of claim 1, wherein the message is generated by a background process on a device.

4. The method of claim 1, wherein the message is generated at a node coupled over a channel to the device.

5. The method of claim 4, wherein the device is playing the media locally and the node obtains information about the media from a database residing on a server on a network using a protocol for delivering and receiving messages between the node and the device.

6. The method of claim 1, wherein the media is a selection being operated by a media player component of the device.

7. The method of claim 1, wherein the device is streaming the media over a network and a node obtains information about the media from one selected from the network, a database server residing on the network and the device.

8. The method of claim 1, further comprising using structure information about the media to modify the generic message so that the specialized message is configured to be seamlessly inserted into the media.

9. The method of claim 8, wherein the generic message is modified based on information or characteristic elements of the media.

10. The method of claim 9, wherein the information about the media is a meta element, meta data, metatag or tag.

11. The method of claim 10, wherein data corresponding to the meta element, meta data, metatag or tag resides on a database server on a network.

12. The method of claim 8, wherein the characteristic elements of the media are selected from the group consisting of tempo, rhythm, pitch, timing and frequency.

13. The method of claim 12, wherein data corresponding to the characteristic elements of the media reside on a database server on a network.

14. The method of claim 1, wherein the media is a musical selection, and the generic message is transformed into a specialized message that is inserted into the music selection in a manner in which the timing, rhythm, tempo, pitch and pacing of the musical selection is relatively undisturbed.

15. The method of claim 1, wherein the media is a vocal selection, and the generic message is transformed into a specialized message that is inserted into the vocal selection in a manner in which the timing, rhythm, tempo, pitch or pacing of the vocal selection is relatively undisturbed.

16. A method for communicating a message to a user of a device, comprising the steps of:
receiving or generating by a device a generic message intended for a user of a device;
determining whether the device is playing any media;
if the device is not playing media, transmitting the generic message;
if it is determined the device is playing media, requesting information or characteristic elements about the media;
determining whether the media can be identified by matching the information or characteristic elements to a database or table of information or characteristic elements;
if the media is not identifiable, transmitting the generic message;
if the media is identifiable, modifying the generic message based on the identified media to create a specialized message;
inserting the specialized message into the media.

17. The method of claim 16, wherein the device is playing the media locally and the node obtains information about the media using a protocol for delivering and receiving messages between the node and the device.

18. The method of claim 17, wherein the media is a selection being operated by the media player component of the device.

19. The method of claim 16, wherein the device is streaming the media over a network and the node obtains information about the media selected from one of the network, a database server residing on the network, and the device.

20. The method of claim 16, further comprising using structure information about the media to modify the generic message so that the specialized message is seamlessly inserted into the media.

21. The method of claim 20, wherein the generic message is modified based on information or characteristic elements of the media.

22. The method of claim 21, wherein the information about the media is a meta element, meta data, metatag or tag, wherein data related thereto resides on a database server on a network.

23. The method of claim 21, wherein the characteristic elements of the media are selected from the group consisting of tempo, rhythm, pitch, timing or frequency, wherein data related thereto resides on a database server on a network.

24. The method of claim 16, wherein the media is a musical selection, and the generic message is transformed into a specialized message that is inserted into the music selection in a manner in which the timing, rhythm, tempo, pitch and pacing of the musical selection is maintained.

25. The method of claim 16, wherein the media is a vocal selection, and the generic message is transformed into a specialized message that is inserted into the vocal selection in a manner in which the timing, rhythm, tempo, pitch or pacing of the vocal selection is maintained.

26. The method of claim 16, further comprising feeding back a response to the device using user generated gestures.

27. The method of claim 26, wherein the generated gestures are compared against a gesture library to determine the nature of the feedback.

28. A node, comprising:
a microprocessor;
a memory further comprised of a non-transitory computer readable medium; and
a wireless module, the microprocessor, memory and wireless module coupled via a bus, the node operable to receive or generate a generic message for communication to a device via the wireless module;
the node further operable to determine whether the device is playing any media and transmit the generic message to the device if it is determined that the device is not playing any media;
the node further operable to request information or characteristic elements about the media if the device is playing media;
the node further operable to determine if the media can be identified by matching the information or characteristic elements to a database or table of information;
the node further operable to transmit the generic message if the media cannot be identified; and
the node further operable to modify the generic message and send it to the device as a specialized message.

29. The node of claim 28, further comprising the node determining the characteristic elements by reference to a separate database on a server coupled to a network.

30. The node of claim 28, further comprising the node inserting the modified message into the media to create the specialized media and transmitting the specialized media to the device.

31. A device, comprising:
An application processor;
a memory further comprised of a non-transitory computer readable medium; and
a wireless module,
an output transducer;
the application processor, memory and wireless module coupled via a bus, the device operable to receive via the wireless module or generate locally a generic message;
the application processor further operable to determine whether a media player on the device is playing any media and convey the generic message if it is determined that the device is not playing any media;
the application processor further operable to obtain information or characteristic elements about the media if the device is playing media;
the application processor further operable to determine if the media can be identified by matching the information or characteristic elements to a local database or table of information or, via the communication processor and wireless module, by reference to an external source;
the device further operable to convey the generic message via a transducer if the media cannot be identified; and
the device further operable to modify the generic message and convey it as a specialized message via the transducer.

32. The device of claim 31, further comprising a sensor coupled to the application processor operable to sense and trigger actions in response to the specialized message.

33. The device of claim 31, further comprising the application processor operable to insert the modified message into the media to create the specialized media and convey the specialized media to a user via the transducer.

34. The device of claim 31, in combination with at least one sensor operable to sense gestures to be interpreted and fed back to the device.

35. The device of claim 34, wherein a sensed gesture is identified by reference to a gesture library.

36. The device of claim 34, wherein the sensed gesture is one selected from the group consisting of body movements and sounds.

37. The device of claim 34, wherein the gesture is interpreted with reference to the rate or tempo of a media file played by the device.

38. The device of claim 34, wherein the nature of the gesture determines an action triggered by the device.
